(19) United States
(12) Patent Application Publication
(10) Pub. No.: US 2002/0052750 A1
(43) Pub. Date: May 2, 2002

(54) Method of business in which GPS golf-course map data is collected and distributed

(76) Inventor: Masaharu Hirooka, Tokyo (JP)

Correspondence Address: DELLETT AND WALTERS, 310 S.W. FOURTH AVENUE, SUITE 1101, PORTLAND, OR, 97204, US

(21) Appl. No.: 09/847,951

(22) Filed: May 2, 2001

(30) Foreign Application Priority Data
May 9, 2000 (JP) 2000-135671

(51) Int. Cl. G06F 17/60

(52) U.S. Cl. 705/1

(57) ABSTRACT

GPS map data on golf courses is collected in a database, through a network when necessary. GPS golf-course map data is sent to users through the network. The fee to be paid by each user and the payment to be made to the person or organization that has the right to the map data is controlled. A golf player can obtain GPS golf-course map data on various golf courses in the same way, easily and at a low price, using a user terminal device, making use of GPS golf-course map data for play by manipulating the user's own user terminal device. Optional information is added to GPS golf-course map data, which the user can choose as needed. Optional information can also be presented based on the records of use of a particular user.

### BACKGROUND OF THE INVENTION

The present invention belongs to the technical field relating to a method of doing the business of collecting and distributing GPS golf-course map data. Particularly, it offers golf-play information as a substitute to that provided by a caddie, and relates to a method of collecting GPS map data on a number of golf courses through a network with the relevant database, transmitting collected GPS golf-course map data to a user terminal device through the network and collecting a fee for such services.

For golf clubs, it is difficult to keep and train caddies. For golf players, the fees for caddies are expensive. Therefore, golf carts and automated caddie-bag carrying systems have become popular recently, as a means of doing away with caddies. Naturally, there is also a demand for a means of obtaining golf-play information normally provided by caddies.

GPS is the abbreviation for “Global Positioning System,” which is a system that is able to calculate the position of a personanywhere on the Earth using twenty-four artificial satellites that revolve around the Earth in a low orbit. GPS was originally developed for military purposes by the United States, and therefore was designed to include errors for outside users. In addition, due to various error factors, natural and artificial, such as “noise” in the reception of GPS data, GPS data may have errors of as much as tens of hundreds of meters. Recently, however, the Geographic Survey Institute under the Ministry of Construction of Japan has started wireless distribution of GPS reference-point data at twenty-two points throughout the nation of Japan. When GPS data is corrected using this reference-point data, the position of a person can be ascertained with a precision of up to several centimeters.

Various systems for providing golf-play information combining GPS with golf-course map data have been proposed. The following are some examples.

(1) GPS golf-cart control system distributed by Hitachi Electronics Co., Ltd.

(2) Navigation systems for a golf course called the “Martial Navi,” distributed by Techno Craft Co., Ltd.

This navigation system is attached to golf carts used by a golf club so that the club can manage the positions of the golf carts in a centralized manner, and so that the players can be given, on a display device of the navigation system, their current positions on the golf course, including other information helpful in playing the hole, such as the distance to the hole, the boundary lines and the position of a bunker. A navigation system of this kind is superior to a skilled caddie. In addition, it enables a player to play a round of golf efficiently and shortens the time required by the player for the round. Thus, a navigation system for a golf course can offer players an opportunity of playing golf at a lower price, because caddies are not needed, and shortens the time it takes to play a round.

(3) Japanese Unexamined Patent Publication Hei 2000-102635 discloses a similar system in which a GPS system is connected to the golf cart.

(4) Golf Technology 2000 Inc. in Canada distributes “Informa GPS Golf 2000,” which is a portable GPS terminal device for use by golf players. This portable GPS terminal device is designed to indicate the position of a player on a map of each hole of the golf course and offer the player play information of various kinds, such as the distance to a hole.

(5) Concepts similar to the GPS terminal device for a golf course are also disclosed in Japanese Unexamined Patent Publication Hei 5-19035, Japanese Unexamined Patent Publication Hei 6-84031, Japanese Unexamined Patent Publication Hei 7-20222, Japanese Unexamined Patent Publication Hei 9-276458, Japanese Unexamined Patent Publication Hei 10-113415 and others.

(6) A device designed to help play by calculating differences between routes for a particular hole at a golf course and information on actual play obtained from GPS and shown to the player is disclosed, for example, in Japanese Unexamined Patent Publication Hei 11-104286 and others.

The conventional techniques described above combine GPS with map data corrected for each golf course, (peculiar data on each golf course), in order to offer information of various kinds to players and to facilitate control by the golf club. Therefore, with these conventional GPS golf systems, a golf clubcan offer GPS portable terminal devices providing GPS golf-course map data on its golf course that is used exclusively on their golf course. A player must rent from the golf club, a GPS portable terminal device adapted for use exclusively for the golf course. When the golf clubs offer provide different types of GPS portable terminal devices, a player cannot concentrate on play until he becomes used to handling a particular terminal device.

It would be convenient for players to have a GPS portable terminal devices that could be used on any golf course in the same way. Such a GPS portable terminal device would require a system that could collect GPS golf-course map data for each golf course in a centralized manner and distribute the collected data to players. In this connection, the United States White House Press Secretary issued a statement on May 1, 2000 to the effect that errors in data from GPS would be eliminated.

These days, the internet has become widely used, and internet service providers have started a service of distributing software and data of various kinds. The service is operated as follows: A person or an organization that has made and/or has a right to software or data registers his or its software or data by uploading it to a database of a provider. The provider presents the registered software or data to a plurality of users on a web page. When a user downloads the registered software or data, the provider requests the user to pay a fee for the use of the software or data, (a royalty), in addition to a provider fee. The provider pays, to the person or organization that has made and/or has a right to the software or data, the fee after deducting a fee for their own service.

Electronic map makers distribute electronic map data to users, using home pages on the internet, charging a fee. Users may pay the fee by credit card or prepaid card. When a user pays by credit card, credit card information is sent through the internet to the server of an organization that has offered the data. The credit card information is coded for protection. When a user pays by prepaid card, it is so arranged that the user has paid for use of data in advance, and that a right to download the data is given to such person after the combination of his user name and password is confirmed.

However, no one has yet proposed that the service of distributing software or data described above be used to handle GPS golf-course map data. Further, the conventional service of distributing data does not allow users to choose additional data to be added to basic data as an option.

These days, in order to do advertisement effectively on the internet, an optimal advertising message is chosen and sent to users, based on personal information relating to each user, (the sex, age, profession, married/unmarried status, children, etc., for the user), provided by the user. However, the user cannot choose the advertising that is sent to him or her. The information is sent automatically to each user based on the personal information on such person.

An object of the present invention is to provide a method of business in which a user terminal device that transmits highly precise golf-play information is combined with an automated caddie-bag carrying system, in order to replace caddies, so that the user can save money on golf play.

Another object of the present invention is to provide a method of business in which GPS map data is collected for golf courses in a centralized manner, maintaining this collected GPS golf-course map data as a database, sending specific GPS golf-course map data to users, (golf players), through a network, and receiving a fee from such users.

Another object of the present invention is to provide a method of business in which GPS golf-course map data adapted in order to offer optional information of various kinds in addition to GPS golf-course map data is collected and distributed in order to increase the value of the GPS golf-course map data, allowing the user to choose optional information as needed.

Another object of the present invention is to provide a method of business in which GPS golf-course map data adapted in order to offer optional information based on records of the specific user.

### SUMMARY OF THE INVENTION

A method of business in which GPS golf-course map data is collected and distributed according to the present invention comprising

a step of registering GPS map data on a number of golf courses in a database connected to a network,

a step of accessing the database through the network, retrieving GPS map data on a desired golf course from the database, and downloading and offering the retrieved GPS map data to a user terminal device, and

a step of preparing data and charging the user for the use of the offered GPS map data.

In one aspect of the method of business in which GPS golf-course map data is collected and distributed according to the present invention, GPS map data on golf courses is uploaded to a database through the network.

In one aspect of the method of business in which GPS golf-course map data is collected and distributed according to the present invention, the network is the internet or a telephone line.

In one aspect of the method of business in which GPS golf-course map data is collected and distributed according to the present invention, the user terminal device has a function that includes GPS and a display device adapted to display GPS golf-course map data and the current position of a player.

In one aspect of the method of business in which GPS golf-course map data is collected and distributed according to the present invention, GPS map data stored in the database includes timer information or counter information, and the user terminal device has a timer function or a counter function that works with the timer information or the counter information.

In one aspect of the method of business in which GPS golf-course map data is collected and distributed according to the present invention, GPS map data stored in the database includes optional information.

In one aspect of the method of business in which GPS golf-course map data is collected and distributed according to the present invention, the optional information includes one or both of the following information; advisory information regarding the optimal approach to a particular hole and information on similar holes.

In one aspect of the method of business in which GPS golf-course map data is collected and distributed according to the present invention, attributes or golf-play records of the user or information on discounts is registered in the database, and the optional information is selectively offered to the user terminal device.

In one aspect of the method of business in which GPS golf-course map data is collected and distributed according to the present invention, GPS map data is prepared by correcting map data obtained from satellite pictures by using data obtained from actual measurements of the configurations of holes at a golf course, the distance to a cup, the configuration of a green, the position and configuration of a bunker and so on.

The present invention makes it possible to collect GPS map data on golf courses through the network when necessary, control the collected GPS golf-course map data as a database, send GPS golf-course map data to users through the network, and control the fee to be paid by each user and the payment to be made to the person or organization that has the right to the map data. With the present invention, a golf club can reduce its expenses, and a golf player can obtain GPS golf-course map data on various golf courses in the same way, easily and at a low price, using a user terminal device obtained in advance, and making use of GPS golf-course map data for play by manipulating the user's own user terminal device. Therefore, a golf club can save the money and time traditionally used to maintain and train caddies. In addition, with the present invention, optional information is added to GPS golf-course map data, which the user can choose as needed. Thus, only the data that a user needs is offered, which can be done at a low price. Further, optional information can be presented based on the records of use of a particular user. This further increases the value of GPS golf-course map data.

### BRIEF DESCRIPTION OF THE DRAWINGS

FIG. 1 is a block diagram schematically showing a system used in a method of business in which GPS golf-course map data is collected and distributed according to the present invention;

FIG. 2 is a flowchart for explaining the entire method of collecting and distributing GPS golf-course map data according to the present invention;

FIG. 3 is a diagram showing the items comprising the golf-course data used in the present invention;

FIG. 4 is a flowchart for explaining in detail how, in the present invention, GPS golf-course map data is registered;

FIG. 5 is a flowchart for explaining in detail how, in the present invention, data is arranged; and

FIG. 6 is a flowchart for explaining in detail how, in the present invention, golf-course data is downloaded.

### EMBODIMENT OF THE PRESENT INVENTION

An embodiment of the present invention is described, based on the attached drawings.

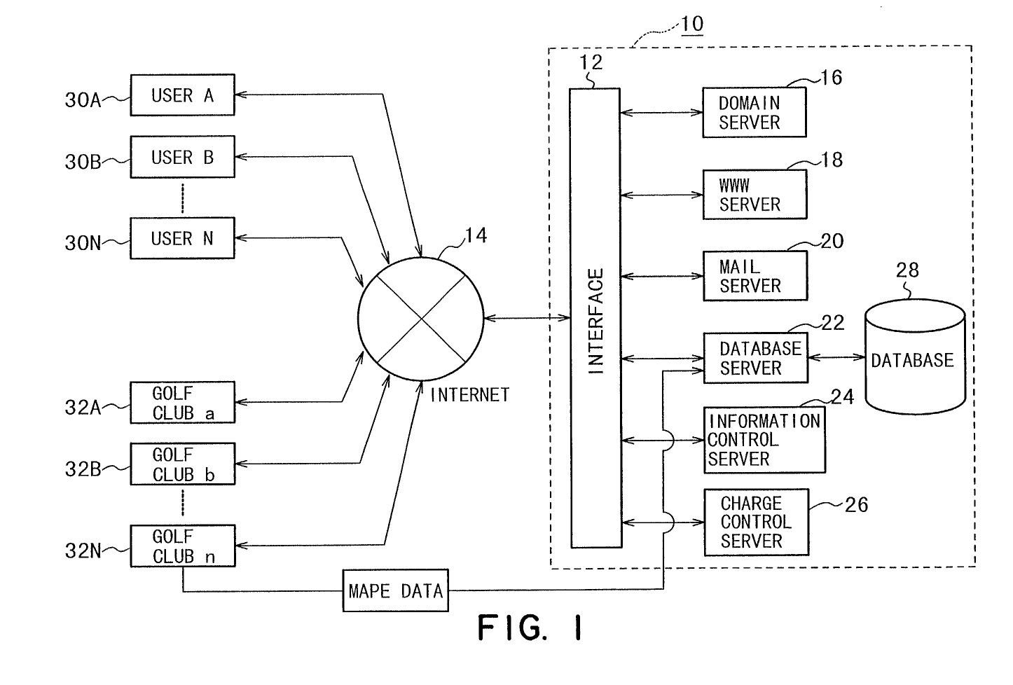

FIG. 1 is a block diagram schematically showing the entire system used in a method of business in which GPS golf-course map data is collected and distributed according to the invention recited in claim 1.

A golf information provider 10, which controls GPS golf-course map data and fees, is connected to a network such as the internet by an interface 12. The interface 12 has functions of a modem, router and firewall, and connects various kinds of servers of the golf information provider 10 and the internet 14. Here, the interface 12 is connected to servers 16˜26. A domain server 16 controls a domain-name system. A WWW server 18 controls a home page where a guide to or an explanation of GPS golf-course map data is offered to users. A mail server 20 is for electronic mail to or from users. The servers 16˜20 are those generally used in a conventional Provider, and therefore, a further detailed explanation is omitted.

A database server 22 controls GPS golf-course map data. As will be described in more detail below, the database server 22 collects GPS golf-course data by uploading it through the network 14, registers it in a mass storage device 28 such as a photo-magnetic disc, and controls it. When necessary, the golf information provider 10 registers GPS golf-course map data received from golf clubs a˜n in the database server 22, directly. A database is organized by the database server 22 and the storage device 28. The database server 22 retrieves GPS map data on the desired golf course from the storage device 28, and sends it to the network 14. An information control server 24 controls information on golf clubs (a˜n) that have offered GPS golf-course map data, information on persons or organizations that have rights to maps, attributes and golf-play records of registered users, and others.

The attributes of a registered user include the name, (handle name), password, real name, home address, correspondence address, birthday, sex and other information of the user. The golf-play records of a registered user include the handicap, years of experience, names of golf courses played on, and other information of the user. Such attributes and golf-play records of registered users are registered in the database. When a user applies for a discounted fee in advance, he or she pays a fixed annual membership fee, and a record to the effect that it is not necessary to charge the user for use of golf-course map data for each download of golf-course map data is registered in the database. The rate of discount can vary. The annual membership fees could be set at $50 to $60.

A charge control server 26 charges the registered users for use of GPS map data offered to them, and also prepares data for use in sharing the charges paid by registered users.

User terminal devices 30A˜30N may be PCs, (personal computers), PDAs, (personal digital assistants), or the like. The user terminal devices 30A˜30N are connected to the internet 14 by ISPs, (internet service providers, not shown). The PDAs have a GPS function and a display device, (monitoring display section), for displaying GPS golf-course map data and current position. The PDAs are those that are consistent with the format of GPS golf-course map data determined by the golf-course information provider 10, and can be used for different golf courses in the same way. Basically, each user buys one and uses it continuously. If the golf club a˜n and the golf information provider 10 are linked, simple GPS terminal devices can be offered to users A˜N at a low price. Golf club terminal devices 32A˜32N are PCs. Each golf club a˜n prepares GPS map data on its golf course in accordance with a determined format, and uploads it to the database of the golf information provider 10 through the internet 14. Map data from golf clubs a˜n may be uploaded to the database as well so that the golf information provider 10 receives map data directly from the golf clubs a n, then arranges it for the GPS, and then uploads it to the database.

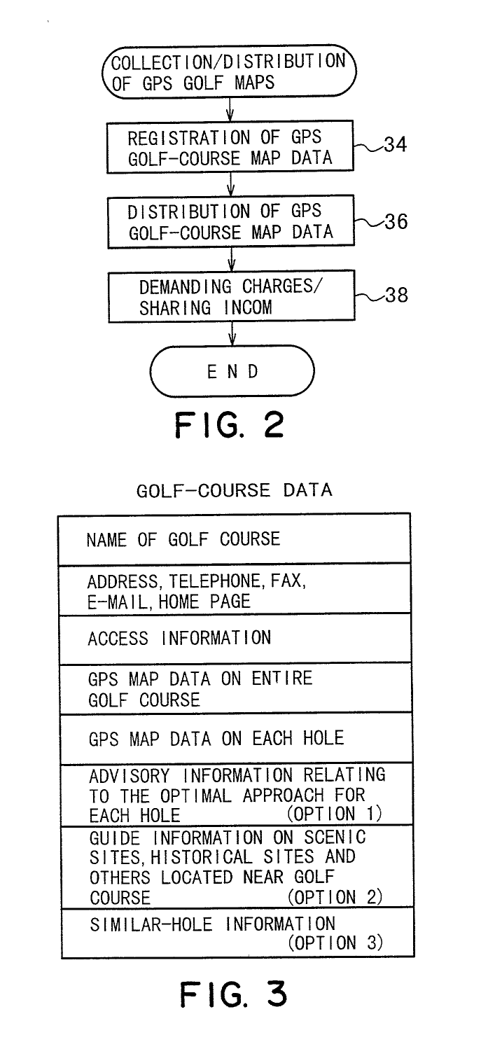

FIG. 2 is a flowchart for explaining the entire method of the business in which GPS golf-course map data is collected and distributed according to the present invention. In step 34, golf clubs and/or those who are hired by golf clubs each prepare GPS map data on each hole of its golf course, in accordance with a determined format. Map data includes all items that are considered necessary for golf play, such as the configuration of each hole, the distance to each cup, the configuration of each green, the position and configuration of each bunker, the position of each pond, the position of each grove, and the density of each grove. Map data can be divided into GPS map data on an entire golf course and GPS map data on the specifics for each hole. When golf-course data includes, in addition to map data of this kind, additional information as shown in FIG. 3, the value of the golf-course data can be increased. “Name of a golf course” is the name of a particular golf course. Information such as “address, telephone number, facsimile number, electronic mail, (e-mail), address, home page address,” is also included. “Access information” refers to instructions on how to reach the golf course in question, using maps and written directions.

In the event GPS map data cannot be obtained due to a club house failing to maintain drawings of their golf course, or the original design drawings of a golf course have become useless due to changes that have been made to the golf course over time, necessary data may be prepared by correcting map data using satellite pictures or using data obtained from actual measurementsof the configuration of each hole, the distance to each cup, the configuration of each green, the position and configuration of each bunker and so on. In order to further increase the value of the golf-course data, “optional information” may be prepared. “Option 1” in FIG. 3 is, for example, advisory information regarding the optimal approach to each hole. It is desirable to combine the advisory information with the GPS map data on each hole, using the HTML, (Hypertext Markup Language) In such case, a golf player using the map data on a golf course can research the optimal approach to a cup from a certain spot on a hole, by clicking on that spot on the display of that hole. The advisory information includes, for example, the surface of a green, the grain of grass, the bumps in or inclination of an intermediate ground, and the depth of a bunker. “Option 2” is guide information on scenic sites, historical sites, hot springs, hotels, restaurants and other information regarding facilities located near the golf course in question. “Option 3” relates to the golf information provider 10 side, and is described below.

The GPS golf-course map data and additional information prepared in the described manner is uploaded to the golf information provider 10 through the internet 14, and stored or registered in the storage device 28 for the database, under the control of the database server 22. The registered GPS golf-course map data is arranged by the database server 22, which is described below.

The users A˜N who intend to use GPS golf-course map data register themselves in the golf information provider 10 in advance. When they register themselves, they give their user attributes and provide a record of their previous golf play. In addition, they may apply for a discounted fee if they wish, as described above. The attributes, golf-play records and application for discount are processed by the information control server 24 and registered in the database.

In step 36 in FIG. 2, users access the golf information provider 10 from user terminal devices 30 such as PDAs having the GPS function, PCs or others, through the internet 14, to download GPS map data and additional information on their desired golf courses. When a user uses a PC as the user terminal device 30, he or she can store the downloaded golf-course map data onto a disc, and transfer the stored data to a PDA with a GPS function when necessary. When a user uses a PDA as the user terminal device 30, he can download necessary GPS golf-course map data, on his way home, on his way to a golf course, or on the golf course, by using a PHS, a cellular phone, or a public phone with an ISDN function.

In step 38 in FIG. 2, the charge control server 26 charges the users A˜N for use of GPS golf-course map data and optional information they have downloaded. The charge is determined to be, for example, about $2 for a one-time download. Charges are collected in accordance with the fee method each user has chosen, for example, by drawing a corresponding amount from a user's credit-card account, by drawing a corresponding amount from a user's bank account automatically, or by subtracting corresponding points from the points given to a user's prepaid card. For this purpose, the charge control server 26 prepares necessary data. Based on the prepared data, charges are collected from the users. Because the GPS map data attracts players, it is conceivable that the golf club would not need to receive a share of the fee paid by a user, and that the golf information provider 10 would receive the entire fee. However, when necessary, it may be so arranged that a fixed percentage of a charge paid by a user is given to a club house that has offered golf-course data, such as GPS golf-course map data, or the person or organization that has made and has a right to the golf-course data, as a fee. In such case, the charge control server 26 may prepare charge-sharing data for the related parties. The charge-sharing data would include the amount that corresponds to a fixed percentage of the fee paid by a user, and information on such user. Based on the fee-sharing data, the fee paid by the user is shared.

In order to collect fees for data use more economically, GPS map data stored in the database 28 can be adapted to include timer information or counter information, and the user terminal device would be adapted to have a timer function or a counter function that works with the timer information or the counter information. For example, the timer information would make the GPS map data unusable 24 or 48 hours after it is downloaded, (nullifying the data). The counter information could make the GPS map data unusable after it is downloaded and accessed two or three times. If a user wished to use GPS map data on the same golf course again, he or she would have to download it again, and pay an additional fee for it.

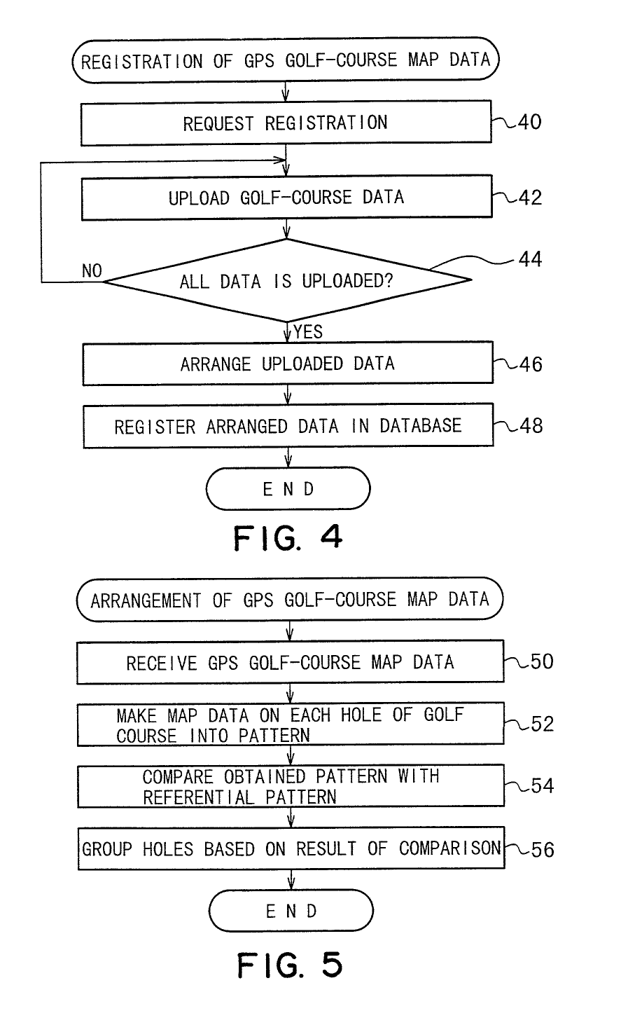

Next, registration of GPS golf-course data in step 34 in FIG. 2 is described based on FIG. 4. Here, it is assumed that the golf club terminal devices 32A˜32N and the golf information provider 10 are already connected through the internet 14. Since the information to be sent between the golf club terminal devices 32A˜32N and the golf information provider 10 is coded when necessary, the club-house terminal devices 32A˜32N and the golf information provider 10 each have an encoding and decoding function. In step 40, registration is requested. Here, required certain data, such as the name of a golf course on which GSP golf-course map data is to be registered, is given. With this, the information control server 24 in FIG. 1 arranges golf-course control data to make the database server 22 ready to receive new data. In step 42 in FIG. 4, golf-course data as has been described based on FIG. 3 is uploaded from a golf club terminal device 32A˜32N into the database server 22. When registration is requested in step 40, additional optional information to be registered if given. Therefore, in step 44, the database server 22 checks whether all the given information has been uploaded or not. If not, the process returns to step 42. If in step 44, it is ascertained that all the given information has been uploaded, the process proceeds to step 46. Since data is uploaded by packet communication using TCP/IP, it can be uploaded free of error. In step 46, the database server 22 arranges the uploaded golf-course data, which is described based on FIG. 5, below. The data arranged in step 46 is registered in the storage device 28, in the data structure shown in FIG. 3.

FIG. 5 is a detailed flowchart of the process of arranging the GPS golf-course map data indicated in step 46 in FIG. 4. In step 50, the database server 22 accepts the GPS golf-course map data uploaded from the golf club terminal device in question 32A˜32N and enters it into a temporary file. In step 52, GPS map data on each hole of the golf course in question is made into a pattern, based on the configuration of the hole in question, (including the deviations from a flat surface). In step 54, the pattern of each hole obtained in step 52 is compared with a referential pattern prepared in advance. In step 56, the holes are grouped based on the result of comparison with the referential pattern in step 54. In this way, holes of a number of different golf courses can be grouped. If a player is going to play on a golf course he or she has never played on before, it may be helpful in approaching the holes to have them compared to similar holes of golf courses on which the player has played in the past. The grouped information is added to the golf-course data as option 3 as shown in FIG. 3.

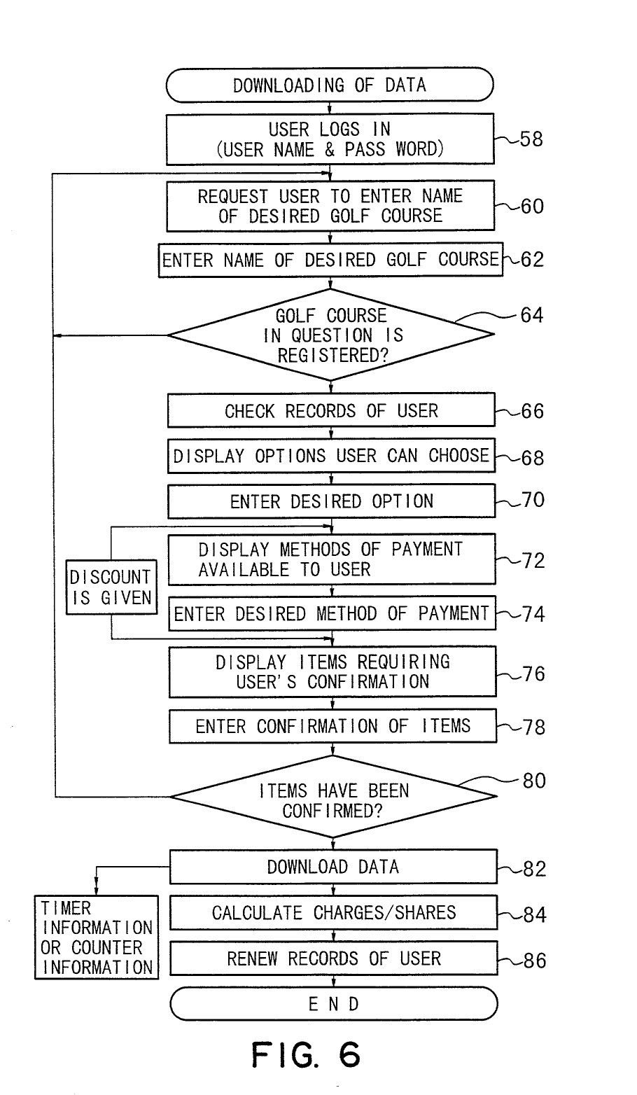

FIG. 6 is a detailed flowchart of the process of downloading golf-course map data indicated in step 36 in FIG. 2. The user terminal devices 30A˜30N shown in FIG. 1 are connected to the golf information provider 10 through the internet 14. The information to be sent between the user terminal devices 30A˜30N and the golf information provider 10 is coded when necessary. In step 58 in FIG. 6, a user logs in by sending his or her user name and password to the information control server 24. When the user succeeds in logging in, the information control server 24 in FIG. 1 requests, in step 60, the user terminal device in question 30A˜30N to enter the name of the desired golf course. In step 62, the user sends the name of the desired golf course from his or her user terminal device 30A˜30N to the information control server 24. In step 64, the information control server 24 communicates with the database server 22 to ascertain whether the golf course in question is registered in the database or not. If not, the process returns to step 60, where the user is informed that the desired golf course is not registered and the user is requested to enter the name of another golf course.

If, in step 64 it is ascertained that the golf course in question is registered, the process proceeds to step 66. In step 66, the information control server 24 in FIG. 1 retrieves the GPS map data that the user has downloaded in the past and ascertains the golf courses the retrieved data relates to. In this way, golf courses on which the user has played in the past are ascertained. In step 68, the information control server 24 displays options that can be chosen by the user on the user terminal device 30A˜30N. If the user has never downloaded GPS map data on any other golf course before, “option 3” indicated in FIG. 3 is not displayed on his user terminal device 30. In step 70, the user enters the desired option from the user terminal device 30A˜30N to give a choice to the information control server 24. In step 72, the information control server 24 displays the methods of payment that may be chosen by the user on his user terminal device 30A˜30N. As described above, the methods of payment the user can choose include payment by credit card, having an amount drawn from a bank account, payment by prepaid card, and others. In step 74, the user provides the preferred payment method to the information control server 24.

If the user is registered as a user provided with a discount, the process proceeds to the display of items that require confirmation by the user.

In step 76, the information control server 24 displays on the user terminal device 30, the information that the user has entered for confirmation by the user, (displaying items that require confirmation by a user). In step 78, the user gives confirmation or denial of the displayed items to the information control server 24. In step 80, the information entered in step 78 is ascertained. If the displayed items have not been confirmed by the user, the process returns to step 60. If the displayed items have been confirmed, the process proceeds to step 82. In step 82, the information control server 24 instructs the database server 22 to retrieve the requested data from the storage device 28, and the retrieved golf-course data including GPS map data is downloaded to the user terminal device 30. The downloaded data includes timer information or counter information.

If “option 3” in FIG. 3 is chosen, and if any of the golf courses on which the user has downloaded data in the past has a hole that belongs to a group of holes similar to any of the holes of the golf course in question, the information on that hole is downloaded as “similar hole” information. As described before, groups of similar holes are arranged as in FIG. 5. With the similar-hole information offered as “option 3”, the user is able to know which holes of the golf course for which the user is downloading data are similar to holes at other golf courses on which the user has played in the past. Thus, the user may be able to plan a strategy based on past experience.

After the golf-course data including GPS golf-course map data is downloaded, the charge control server 26 in FIG. 1 calculates, in step 84, the amount of money to be charged the user, based on the user's choice of options and others. When necessary, it calculates the amount of money to be paid to the golf club in question, (the person or organization that has a right to the golf-course data). The result of calculation is used in step 38 in FIG. 2. In step 86 that follows step 84, the information control server 24 renews the records of the user in accordance with information from the current download, including the golf course and the user's choice of options. With this, the process of downloading GPS map data on a golf course ends.

Using the downloaded GPS map data, the user may, if he or she wishes, prepare a strategy for the golf course prior to going to the golf course. Further, if the GPS map data is transferred to a PDA with a GPS function, the GPS map data can be utilized effectively on the actual golf course, as a source of information on the optimal approach to each hole as a substitute for the advice from a caddie. Therefore, as long as a golf course is provided with an automated caddie-bag carrying system, (golf carts for riding or private caddie-bag carts), players can well enjoy playing in private.

The desirable embodiment of the present invention has been described above. It is to be noted that various modifications or changes can be made without departing from the concept of the present invention. For example, when data including GPS golf-course map data is registered in a database, recorded or sent to a user, it may be uploaded to or downloaded from a database, using a direct connection by telephone lines as a network, in place of using the internet. Further, it may be so arranged that data including GPS golf-course map data prepared by each golf club is recorded on a mass storage medium such as a CD-ROM, CDR/W, or Zip and delivered to a golf information provider. In such case, this data could be registered and stored directly from a database server. Further, advisory information as to how to approach each hole, which is offered as optional information, could be prepared to match the levels of specific players. A beginners' level, an intermediate level or an advanced level could be automatically offered to a user based on the user's handicap and experience.

What is claimed is:

1. A method of business in which GPS golf-course map data is collected and distributed, comprising
a step of registering GPS map data on a plurality of golf courses in a database connected to a network,
a step of accessing said database through said network, retrieving said GPS map data on a desired golf course among said plurality of golf courses, from said database, and downloading and thereby offering said retrieved GPS map data to a user terminal device, and
a step of preparing data for use in charging a user for use of said offered GPS map data.

2. A method of business in which GPS golf-course map data is collected and distributed according to claim 1, wherein said GPS map data on said plurality of golf courses is uploaded to said database through said network.

3. A method of business in which GPS golf-course map data is collected and distributed according to claim 1, wherein said network is internet or telephone lines.

4. A method of business in which GPS golf-course map data is collected and distributed according to claim 1, wherein said user terminal device has a GPS function and a display device adapted to display said GPS map data and a current position of said user.

5. A method of business in which GPS golf-course map data is collected and distributed according to claim 1, wherein said GPS map data stored in said database includes timer information or counter information, and said user terminal device has a timer function or a counter function that works with said timer information or said counter information.

6. A method of business in which GPS golf-course map data is collected and distributed according to claim 1, wherein said GPS map data stored in said database includes optional information.

7. A method of business in which GPS golf-course map data is collected and distributed according to claim 6, wherein said optional information includes at least one of two kinds of information, that is, advisory information regarding an optimal approach to playing a hole of golf and information on similar holes of golf at other golf courses.

8. A method of business in which GPS golf-course map data is collected and distributed according to claim 6, wherein attributes or golf-play records of said user or information on discounts to be provided to said user is registered in said database, and said optional information is selectively offered to said user terminal device based on said attributes or golf-play records of said user.

9. A method of business in which GPS golf-course map data is collected and distributed according to any one of claims 1 to 8, wherein said GPS map data is prepared by correcting map data obtained from satellite pictures by using data obtained from actual measurements of configurations of individual holes of a golf course, a distance to a cup, configuration of a green, position and configuration of a bunker, and other measurements.
